(19) United States
(12) Patent Application Publication
(10) Pub. No.: US 2011/0094344 A1
(43) Pub. Date: Apr. 28, 2011

(54) Apparatus and Method for Cutting Roofing Material

(76) Inventor: Wendell Weedon, Prescott, AZ (US)

(21) Appl. No.: 12/604,266

(22) Filed: Oct. 22, 2009

(51) Int. Cl. E04D 15/00; B26D 1/15

(52) U.S. Cl. 81/45; 30/296.1; 83/13; 30/320; 30/319; 52/749.12

(57) ABSTRACT

An apparatus for cutting roofing material includes a non-motorized wheeled cart with an adjustable weight and a pull handle for pulling the wheeled cart along the roof. A hand-operated jack is mounted to the cart and supports a cutting wheel. The jack can be operated to move the cutting wheel between a raised position wherein the cutting wheel is disengaged from the roofing material and a cutting position wherein the cutting wheel can engage and cut the roofing material. The adjustable weight can include weight members removably mounted to the cart.

### BACKGROUND

The present invention relates generally to apparatus and methods for cutting roofing material to be removed from a roof. More particularly, it relates to an improved, wheeled roofing cutter that is adjustable in weight, that has a cutting wheel easily movable between a raised position above the roofing material and a cutting position in engagement with the roofing material and that does not require motorized power.

Commercial and residential building constructions generally have roof decks that are covered with a protective layer of shingles or other roofing material. Shingles are placed in overlapping, aligned rows and are secured in place by a combination of adhesives, nails, staples or other fasteners. Another conventional roof construction is the built-up roof which utilizes rolled roofing material having an asphalt base laid in strips in overlapping or abutting relationship. The strips are secured to the deck by use of adhesives or fasteners. For flat or semi-flat roofs, hot mopped asphalt roofing is often used, particularly in commercial applications.

Any roofing material, regardless of type, will eventually deteriorate due to exposure to ultraviolet from the sun, moisture from precipitation, etc. While it is common to install a second layer of new roofing material over a single existing layer, eventually the older roofing material must be removed for replacement.

Various devices can be found in the prior art to assist roofers in cutting old roofing material for removal from a roof. All of these have their shortcomings. A tool commonly used for this purpose is the shingle cutting knife, which is used to cut old roofing material. In addition to presenting safety issues, the use of this type of tool is labor intensive, extremely taxing physically and time consuming. Typically, the labor cost for removing the old roofing material from a residential or commercial structure is a major expense of re-roofing the structure.

Motorized devices for removing or stripping roofing material are also known; however, these machines also have drawbacks. Because they include a motor, they are relatively heavy and cumbersome to place on a roof and are relatively expensive to manufacture and purchase. They require a power source, which may not be readily available and adds additional expense of operation. Moreover, motorized cutting blades need frequent maintenance and cleaning because they spin at high enough speeds to cause the roofing material to become viscous and accumulate on the blades.

Thus, there is a need in the industry for an efficient, convenient, cost effective and safe apparatus and method for cutting roofing material for removal from roofs. It is an object of the present invention to provide such an apparatus and method.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided an apparatus for cutting roofing material for removal from a flat roof. The apparatus includes a wheeled cart having a cart frame, an adjustable weight mounted to the cart frame and a pull handle for pulling the wheeled cart along the roof. The cart frame can include one or more fork lift pockets for receiving the tines of a fork lift. A cutting wheel is supported by the cart frame so that the cutting wheel rotates when the cart is pulled along the roof with the cutting wheel engaging the roofing material. The cutting wheel is movable between a first position above the roof wherein the cutting wheel is disengaged from the roofing material and a second position wherein the cutting wheel can engage the roofing material.

According to one embodiment of the invention, a hand-operated jack is mounted to the cart frame and supports the cutting wheel. Operation of the jack moves the cutting wheel between the first position and the second position.

According to another aspect of an embodiment of the invention, the cart frame has at least one shaft projecting from the frame for receiving one or more weight members. The weight members can be removably mounted on the shaft. The shaft can be threaded for securing the weight members to the shaft. In one example of this embodiment, the overall weight of the apparatus can be adjusted from about 90 pounds to about 300 pounds.

A method for cutting roofing material for removal from a roof in accordance with the invention includes providing an apparatus with a wheeled cart that includes a cart frame, a pull handle for pulling the wheeled cart along the roof, an adjustable weight mounted to the cart frame, and a cutting wheel supported by the cart frame so that the cutting wheel rotates when the wheeled cart is pulled along the roof with the cutting wheel engaging the roofing material. The cutting wheel is movable between a first position above the roof wherein the cutting wheel is disengaged from the roofing material and a second position wherein the cutting wheel engages the roofing material. The method includes positioning the wheeled cart on the roof with the cutting wheel in the first position, moving the cutting wheel into the second position and pulling the wheeled cart along the roof, whereby the cutting wheel engages and cuts the roofing material for removal from the roof. The cutting method can include adjusting the adjustable weight to optimize the cutting of the roof material.

According to one advantageous method of the invention, the step of positioning the wheeled cart on the roof can be performed before increasing the weight to optimize the cutting of the roof material. Positioning the wheeled cart on the roof can include inserting tines of a fork lift into lift pockets on the wheeled cart with the fork lift.

### BRIEF DESCRIPTION OF THE DRAWINGS

The accompanying drawings, which are incorporated in and constitute a part of the specification, illustrate the presently preferred embodiments of the invention, and together with the general description given above and the detailed description of the preferred methods and embodiments given below, serve to explain the principles of the invention.

FIG. 1 is a side perspective view of one embodiment of a roofing cutter according to the present invention, showing the cutting wheel in a raised position above and disengaged from the roofing material;

FIG. 2 is a side perspective view of the roofing cutter of FIG. 1, showing the cutting wheel in a cutting position engaging the roofing material;

FIG. 3 is a front perspective view of the roofing cutter of FIG. 1, showing the front axle and pull handle;

FIG. 4 is a top perspective view of the platform of the roofing cutter of FIG. 1, showing in more detail how the jack and removable weight members are mounted to the platform.

### DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

It will be appreciated that terms such as “upper,” “inner,” “outer,” “vertical,” “horizontal,” “bottom,” “below,” “top,” “side,” “inwardly,” “outwardly,” “downwardly” and “lower” and other positional descriptive terms used in this specification are used merely for ease of description and refer to the orientation of the referenced components as shown in the Figures. It should be understood that any orientation of the components described herein is within the scope of the present invention. The term “generally” as used in this specification is defined as “being in general but not necessarily exactly or wholly that which is specified.” For example, “generally perpendicular” is used herein to indicate components that are in general, but not necessarily exactly or wholly, perpendicular.

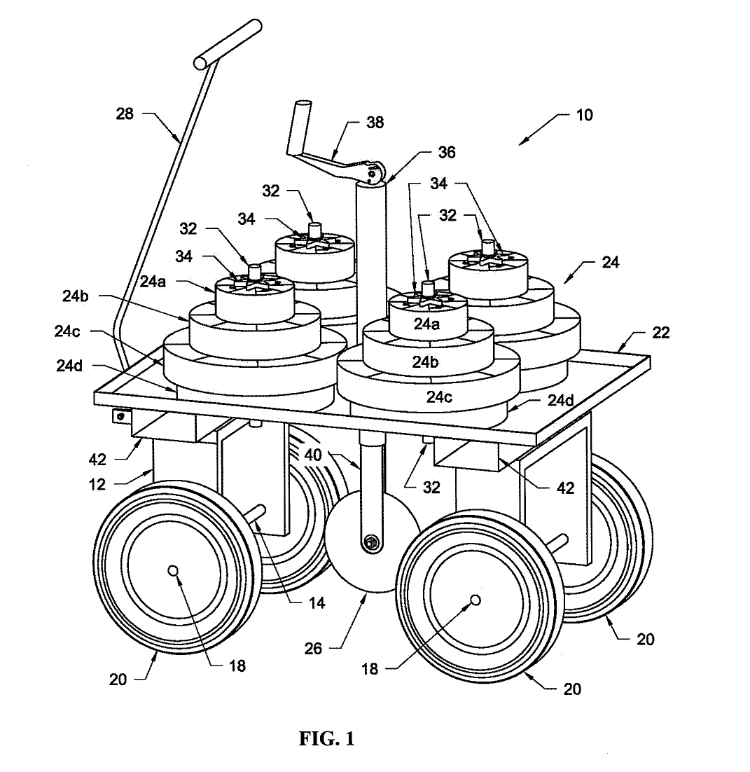

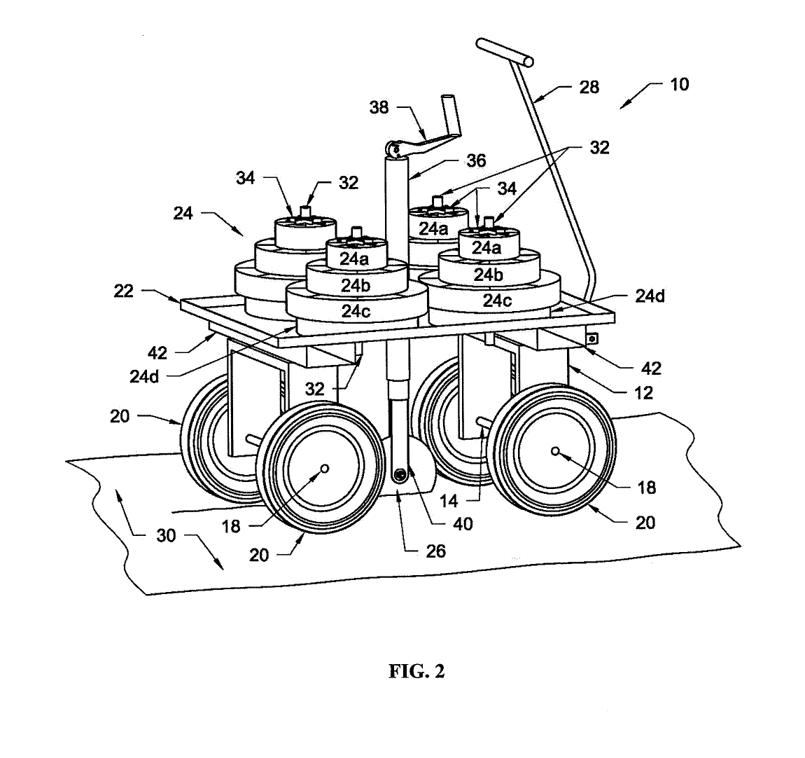

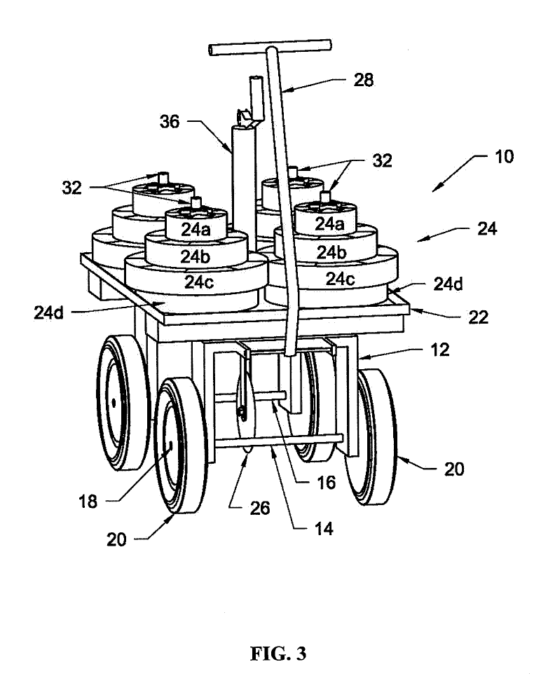

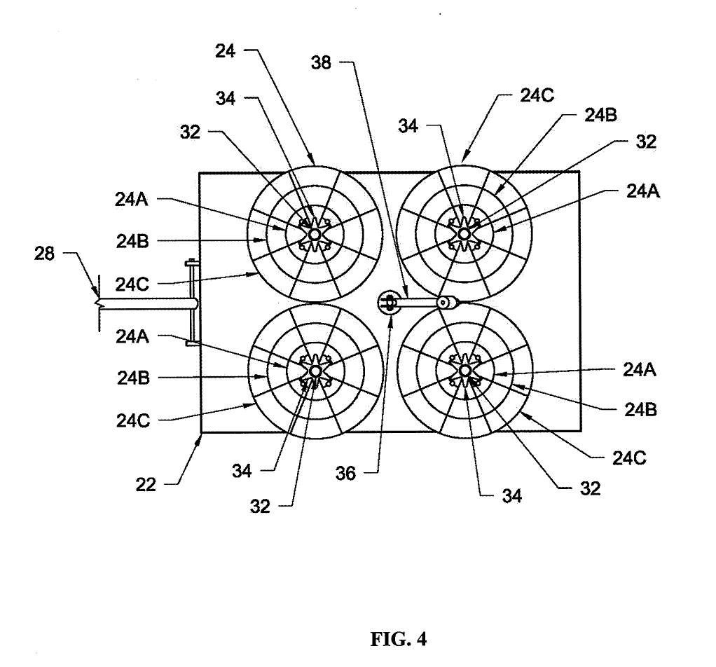

Referring to FIGS. 1-4, the reference numeral 10 generally designates a roofing cutter in accordance with the invention. The roofing cutter 10 includes a cart frame 12 with a front axle 14 and a rear axle 16 onto which are mounted wheels 18 and tires 20. The cart frame 12 supports a platform 22 which is adapted to hold an adjustable weight 24 for adjusting the overall weight of the roofing cutter 10 to provide optimal cutting operation for a wide range roofing materials and conditions. A pull handle 28 is coupled to the front of the cart frame 12 for pulling the roofing cutter 10 by hand along the surface of a roof 30. For steering and ease of use, the front axle 14 preferably steerable. To achieve this, the front axle 14 is attached to a rotating mechanism, which is mounted to the cart frame 12 and is pivotally attached to an end of the pull handle 28, such as is well known in the construction of small wagons. A cutting wheel 26 is supported below the platform 22 so that the cutting wheel rotates when the roofing cutter 10 is pulled along the roof 30 with the cutting wheel 26 engaging the roofing material. The height of the cutting wheel 26 is adjustable to allow for adjustment in the depth of the cut made when the cutting wheel 26 engages the roofing material. Preferably, the cutting wheel 26 is removable so that it can be removed for maintenance or replacement.

In the embodiment of FIGS. 1-4, the adjustable weight 24 is provided by weight members 24a, 24b, 24c, 24d, which are removably mounted to the platform 22. One or more threaded shafts 32 are fixed to the platform 22 so that they project above the platform in a generally perpendicular orientation. Each of the weight members 24a, 24b, 24c, 24d is in the form of a plate with a center hole dimensioned to receive the threaded shaft 32. One suitable from of weight member is the type of weight plates used for barbell exercise equipment. With one or more of the weight members 24a, 24b, 24c, 24d disposed on the shaft 32, a threaded collar or retaining nut 34 is screwed onto the shaft to secure the weight members 24a, 24b, 24c, 24d on the shaft 32. By providing multiple shafts 32 and weight members 24a, 24b, 24c, 24d of various weights, the overall weight of the roofing cutter 10 can be adjusted to provide optimal operation for cutting a wide range of different roofing materials.

As shown in FIGS. 1-3, the frame 12 can include lift pockets 42 for receiving the tines of a fork lift, which can be used to lift the roofing cutter 10 into position on a roof.

Still referring to FIGS. 1-4, a jack 36 is mounted to the platform 22 for manually adjusting the height of the cutting wheel 26. The upper end of the jack 36 projects above the platform 22 and has a hand crank 38 for manually operating the jack 36. The opposite, lower end of the jack projects below the platform 22 and has a fork 40 that rotatably supports the cutting wheel 26 in a position generally parallel to the wheels 18. The jack 36 is fixed to the platform 22 at a point between the jack upper and lower ends, such as by welding, so that the jack 36 is generally perpendicular to the platform 22. The cutting wheel can be removably mounted to the fork 40 using a mounting bolt with a lock washer and nut combination (not shown). To hold the cutting wheel 26 in position in the fork 40, a spacer (not shown) is disposed on the mounting bolt on each side of the cutting wheel 26 between the fork 40 and the cutting wheel 26. In this configuration, the position of the cutting wheel 26 relative to the supporting platform 22 can be adjusted by manually operating the jack 36 in the upward and downward directions using the hand crank 38. The jack 36 also is fixed to the platform 22 between the jack upper and lower ends so that it provides the appropriate range of adjustment in the height of the cutting wheel 26 to allow for the desired depth of the cut made when the cutting wheel 26 engages the roofing material.

In one exemplary embodiment of the invention, the cart frame 12 and platform 22 are fabricated from metal, such as steel. Upon reading this disclosure, however, those of skill in the art will recognize that the cart frame 12 and platform 22 may be fabricated from other suitable material, such as aluminum or other suitable metals. In the exemplary embodiment, the platform 22 is made of 12-gauge plate steel and has 1½-inch lip around the edge. It is about 36 inches long and 24 inches wide and the top surface of the platform 22 is about 19 inches above the bottom of the tires 20. The wheels 18 are about 8 inches in diameter and the tires 20 are inflatable 4.10/3.50-6 tires with an overall diameter of about 12 inches.

In this exemplary embodiment, the jack 36 is a hand crank trailer tongue jack with an A-frame mounting bracket, such those manufactured for recreational vehicle trailers. The jack 36 is disposed within a hole cut in the platform 22 and is fixed to the platform 22 by welding the jack mounting bracket to the bottom of the platform 22. The top of the jack 36 is about 16 inches above the platform 22. The fork 40 is welded to the bottom end of the jack 36. The cutting wheel 26 is 7⅝-inch toothed circular saw blade. The bottom of the cutting wheel 26 can be adjusted from a height of about 6 inches to 8 inches above the bottom of the tires 20 to about 2½ inches below the bottom of the tires 20. Four threaded shafts are welded into holes in the platform 22. Without the weight members 24, the roofing cutter 10 weighs about 90 to 100 pounds. The weight members 24 are two sets of barbell weight plates of 100 pounds per set, i.e., the total weight of all of the weight members 24 is about 200 pounds. In this configuration, the overall weight of the roofing cutter can be adjusted from about 90 pounds to about 300 pounds by adding or removing weight members 24.

To use the roofing cutter 10 in accordance with my invention, it first must be positioned on a roof 30 from which old roofing material is to be cut for removal. To facilitate this, the user can remove the weight members 24 while the roofing cutter 10 is being lifted onto the roof 30. During this placement process, preferably the cutting wheel 26 is moved into a raised position. The roofing cutter 10 can be conveniently lifted with a fork lift by inserting the fork lift tines into the lift pockets 42 of the roofing cutter 10. To reduce the weight of the roofing cutter 10 for lifting, it can be positioned on the roof without the weight members 24, which can be secured to the platform 22 later to adjust the weight to for cutting.

The roofing cutter 10 can be operated by one or two people. Suitable weight members 24 can be secured to the shafts 32 on the platform 22 so that the overall weight of the roofing cutter 10 is optimal for cutting the roofing materials to be removed. The user moves the cutting wheel 26 into a cutting position so that it engages the roofing material and provides the desired depth of the cut by turning the hand crank 38 of the jack 36. The pull handle 28 can then be used to pull the roofing cutter 10 along the surface of the roof 30 in a generally straight line. During this process, the cutting wheel 26 engages and roofing material and rotates, thereby cutting the material for removal from the roof. After a cut is complete, the roofing cutter 10 can be turned to make the next cut by raising the cutting wheel 26 until it disengages from the roofing material.

From the foregoing it should be apparent that the invention provides an improved method and apparatus for cutting roofing material that is efficient, convenient, cost effective and safe in comparison to prior apparatus and methods.

Having read this disclosure, it will also be understood by those having skill in the art that the modifications may be made to the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. An apparatus for cutting roofing material for removal from a roof, the cutting apparatus comprising:
a wheeled cart including a cart frame;
a pull handle for pulling the wheeled cart along the roof;
an adjustable weight mounted to the cart frame; and
a cutting wheel supported by the cart frame so that the cutting wheel rotates when the wheeled cart is pulled along the roof with the cutting wheel engaging the roofing material;
the cutting wheel being movable between a first position above the roof wherein the cutting wheel is disengaged from the roofing material and a second position wherein the cutting wheel engages the roofing material.

2. The cutting apparatus of claim 1 wherein the cutting wheel is supported by a jack for moving the cutting wheel between the first position and the second position.

3. The cutting apparatus of claim 1 wherein the adjustable weight comprises one or more weight member removably mounted to the cart frame.

4. The cutting apparatus of claim 3 wherein cart frame includes at least one shaft projecting from the frame for receiving the one or more weight members.

5. The cutting apparatus of claim 4 wherein the weight receiving shaft is threaded for securing the one or more weight member to the shaft.

6. The cutting apparatus of claim 1 wherein the wheeled cart includes inflated tires.

7. The cutting apparatus of claim 1 wherein the weight of the apparatus can be adjusted from about 90 pounds to about 300 pounds.

8. The cutting apparatus of claim 1 wherein the wheeled cart includes a member for receiving the tine of a fork lift.

9. A method for cutting roofing material for removal from a roof, the method comprising:
providing an apparatus comprising:
a wheeled cart including a cart frame;
a pull handle for pulling the wheeled cart along the roof;
an adjustable weight mounted to the cart frame; and
a cutting wheel supported by the cart frame so that the cutting wheel rotates when the wheeled cart is pulled along the roof with the cutting wheel engaging the roofing material;
the cutting wheel being movable between a first position above the roof wherein the cutting wheel is disengaged from the roofing material and a second position wherein the cutting wheel engages the roofing material;
positioning the wheeled cart on the roof with the cutting wheel in the first position;
moving the cutting wheel into the second position; and
pulling the wheeled cart along the roof;
whereby the cutting wheel engages and cuts the roofing material for removal from the roof.

10. The cutting method of claim 9 wherein:
the cutting wheel is supported by a jack mounted to the cart frame for moving the cutting wheel between the first position and the second position; and
the step of moving the cutting wheel into the second position comprises operating the jack.

11. The cutting method of claim 9 further comprising adjusting the adjustable weight to optimize the cutting of the roof material.

12. The cutting method of claim 11 wherein:
the cart frame includes at least one shaft projecting from the frame for receiving the weight member; and
the step of adjusting the adjustable weight to optimize the cutting of the roof material includes placing the weight member on or removing the weight member from the shaft.

13. The cutting method of claim 12 wherein the weight receiving shaft includes threads for securing the weight member to the shaft.

14. The cutting method of claim 9 wherein:
the wheeled cart includes a lifting member for receiving the tine of a fork lift; and
the step of positioning the wheeled cart on the roof with the cutting wheel in the first position includes receiving the tine of the fork lift in the lifting member and lifting the wheeled cart with the fork lift.

15. The cutting method of claim 11 wherein the step of positioning the wheeled cart on the roof is performed before the step of adjusting the weight to optimize the cutting of the roof material.

16. An apparatus for cutting roofing material for removal from a roof, the cutting apparatus comprising:
a wheeled cart including a cart frame having at least one shaft projecting from the frame for receiving a weight member;
at least one weight member removably mounted on the shaft;
a pull handle for pulling the wheeled cart along the roof;
a cutting wheel supported by the cart frame so that the cutting wheel rotates when the wheeled cart is pulled along the roof with the cutting wheel engaging the roofing material; and
a jack mounted to the wheeled frame and supporting the cutting wheel for moving the cutting wheel between a first raised position wherein the cutting wheel will not engage a generally flat roof upon which the wheeled cart is positioned and a second cutting position wherein the cutting wheel will engage the roof.

17. The cutting apparatus of claim 16 wherein the cutting position of the cutting wheel is adjustable so that the bottom of the cutting wheel can be any depth from zero inches to about 2½ inches below the surface of the roof.

18. The cutting apparatus of claim 16 wherein the wheeled cart includes inflated tires.

19. The cutting apparatus of claim 16 wherein the weight of the apparatus can be adjusted from about 90 pounds to about 300 pounds.

20. The cutting apparatus of claim 16 wherein the wheeled cart includes a member for receiving the tine of a fork lift.
